(19) United States
(12) Patent Application Publication
(10) Pub. No.: US 2004/0124378 A1
(43) Pub. Date: Jul. 1, 2004

(54) Apparatus for cutting specimens having an automatic presetting apparatus

(76) Inventors: Reinhard Lihl, Vienna (AT); Felix Redl, Vienna (AT)

Correspondence Address: Robert P. Simpson, Esq., Simpson & Simpson, PLLC, 5555 Main Street, Williamsville, NY, 14221, US

(21) Appl. No.: 10/734,566

(22) Filed: Dec. 12, 2003

(30) Foreign Application Priority Data
Dec. 14, 2002 (DE) DE 102 58 553.9

(51) Int. Cl. G06M 7/00; G01V 8/00

(52) U.S. Cl. 250/559.12; 250/221

(57) ABSTRACT

In cutting devices (10), it is necessary to preset the specimen (14) onto the knife (16). The use of a light barrier (30) is proposed in order to facilitate and automate this presetting operation, which is intended to ensure maximally rapid and accurate positioning of the knife (16) relative to the specimen (14). The light barrier (30) is positioned between the knife (16) and the specimen (14), and is preferably arranged parallel to the knife edge (15). As soon as the light barrier (30) is interrupted, a defined spacing (25) between knife (16) and specimen (14) is ascertained, and is used to shut off the automatic feed or to switch over to a different drive system.

### CROSS REFERENCE TO RELATED APPLICATIONS

This application claims priority of the German patent application 102 58 553.9-52 which is incorporated by reference herein.

### FIELD OF THE INVENTION

The invention concerns an apparatus for cutting into specimens, in particular a microtome or ultramicrotome, as well as a method for bringing a specimen close to a knife of a microtome or ultramicrotome.

### BACKGROUND OF THE INVENTION

In the operation of cutting apparatuses, in particular a microtome or ultramicrotome, it is routinely necessary to position the specimen exactly with respect to the knife in accurately positioned and rapid fashion. Care must be taken that neither the knife nor the specimen is damaged in this so-called “presetting” operation. It is correspondingly necessary to prevent inadvertent contact from occurring between knife and specimen. It has therefore been common for some time, in the context of the presetting operation between knife and specimen, to observe through a stereomicroscope as the knife and specimen approach one another. This observation does not always, however, result in a reliable estimate of the spacing between the specimen and the knife edge. Technical presetting aids have therefore also been used for some time, for example a base-mounted illumination system, with which it is possible to illuminate a gap between the knife and specimen, and on the basis of the illuminated gap to allow a better evaluation of the spacing between specimen and knife. The surface of the specimen to be cut into is, however, usually irregularly shaped before the first cut, so that this action as well only partially achieves the goal.

To solve this problem, it is already known from DE 41 11 689 to provide a force sensor that is mounted on the specimen or knife. The cutting force is sensed with the aid of this force sensor, so that it is possible to ascertain when the first cut occurs. In order to carry out the method, once an initial coarse positioning of the knife with respect to the specimen has been performed, the spacing between specimen and knife is decreased at a high feed and cutting speed. As soon as the specimen touches the knife for the first time, the force sensor responds. From that time on, operation switches to a selectable (usually slower) cutting speed, and a specific desired cut thickness is maintained. In order to minimize stress on the specimen and knife, however, the first cuts after presetting must also not be too thick. For many diamond knives, a cut thickness of 0.3 μm is considered the upper limit. This means that before cutting operation begins, alignment of the knife and specimen must be accomplished to an accuracy of a few micrometers without contact between the knife and specimen. The method proposed in DE 41 11 689 cannot guarantee this, however. The first contact between knife and specimen takes place at high speed, so that damage to the knife and specimen can thereby occur.

In order to improve the presetting operation and to automate presetting, with the intent of simultaneously avoiding uncontrolled contact between the knife and specimen, EP 544 181 has proposed a method and an apparatus for automatic presetting. For this, there is mounted on the knife holder a so-called limiting device which is provided in order automatically to ascertain the proximity of the specimen holder along with the specimen secured therein. At the same time, the drive device is intended to switch off in timely fashion so that damage to the knife blade and to the specimen is reliably prevented. To ensure this, a movable plate having a microswitch located behind it is provided on the knife holder. In the presetting operation, the specimen is moved toward this plate until the switching point of the microswitch is reached. A disadvantage of this method, however, is the fact that contact between the specimen and the plate is necessary. In addition, the microswitch does not have the requisite repeatability in the micrometer range.

### SUMMARY OF THE INVENTION

It is therefore the object of the present invention to propose a reliable measurement system that permits non-contact and accurate measurement of the spacing between knife and specimen.

According to the present invention, this object is achieved by a cutting apparatus for cutting a specimen comprising: a knife, defining a knife edge, a knife holder for clamping the knife, a specimen holder for holding the specimen, a feed device for generating a relative motion between the knife and the specimen, a light barrier being arranged parallel to the knife edge and located between the knife and the specimen, the arrangement of the light barrier is such that the relative motion between the knife and the specimen penetrates the light barrier and thereby ascertains a spacing between the knife and the specimen.

It is a further object of the present invention to propose a microtome or an ultramicrotome that permits non-contact and accurate measurement of the spacing between the knife and the specimen.

The above object is achieved by a microtome or ultramicrotome comprising: a knife, defining a knife edge, a knife holder for clamping the knife, a specimen holder for holding a specimen, a feed device for generating a relative motion between the knife and the specimen, a light barrier being arranged parallel to the knife edge and located between the knife and the specimen, the arrangement of the light barrier is such that the relative motion between the knife and the specimen penetrates the light barrier and thereby ascertains a spacing between the knife and the specimen.

It is as well an object of the invention to provide a method which allows a defined spacing between the specimen to be cut and the specimen holder.

The object is achieved by a method for bringing a specimen close to a knife of a microtome or ultramicrotome, comprising the steps of:

securing the specimen in a specimen holder and the knife in a knife holder (24);

moving the specimen and the knife toward one another with the aid of a feed device;

providing a light barrier between the knife and the specimen, wherein the light barrier being arranged parallel to a knife edge of the knife;

interrupting the motion of the specimen and the knife toward one another at a defined; and

ascertaining a defined spacing between the knife and the specimen upon the interruption of the light barrier.

According to the present invention, therefore, there is provided between the knife and the specimen a light barrier which is penetrated as the knife approaches the specimen, i.e. as the spacing between knife and specimen becomes shorter. The light barrier is arranged between the knife and the specimen in such a way that upon penetration of the light barrier, a defined spacing between the knife and the specimen can be deduced. Although the light beam of the light barrier can in principle be arranged in any desired direction in a plane that lies perpendicular to the displacement direction of the feed device, it is particularly advantageous if the light beam extends parallel to the blade of the knife. At the same time, the light barrier is arranged in such a way that upon interruption of the light barrier, a predetermined spacing still exists between the knife and the specimen. This spacing is preferably selected so that upon penetration of the light barrier there is no contact between the specimen and the knife, but instead the spacing (preferably a few micrometers) between specimen and knife is maintained. For that purpose, the light barrier can be e.g. mechanically coupled to the knife and oriented at a defined spacing and in a defined direction with respect to the knife edge. It is thereby possible either to move the knife toward the specimen or the specimen toward the knife, or to move the specimen and knife toward one another. The light barrier can also be mounted on the specimen in such a way that it is at a defined spacing from the specimen. With this solution as well, it is possible to move the knife toward the specimen, the specimen toward the knife, or the specimen and knife toward one another. Lastly, it is also possible to install the light barrier adjustably in a side wall of the cutting apparatus, although it is then favorable to move either the specimen toward the knife or the knife toward the specimen.

In all the configurations mentioned above, the light barrier is penetrated by the knife or by the specimen. A knowledge of the exact distance between the knife blade and the light beam then also yields the spacing between the knife and the specimen, which in this case is known and defined. The presetting operation is complete, and the cutting operation can be initiated.

The use, according to the present invention, of the light barrier also makes possible a completely automated presetting operation. For this purpose, after a coarse positioning between knife and specimen at a spacing of a few millimeters, the motorized cutting motion is activated. The spacing between specimen and knife is thereby decreased. Feed can be performed on both the specimen side and the knife side. The feed operation remains active until an interruption of the previously positioned light barrier (30) occurs for the first time. Once the light barrier has been penetrated, a defined spacing between knife and specimen is detected, so that the first approach operation is complete. The feed can now be switched off. Alternatively, it is also possible to switch automatically to a desired cut thickness and/or speed. This means that after a few cycles without cutting, the specimen is cut into at the desired cut thickness.

The light barrier can be implemented using any desired light transmitter and a receiver tuned thereto. It is inherently possible to use any desired and suitable electromagnetic radiation. Preferably, however, a laser beam is used in order to achieve the smallest possible beam cross section for the sake of the requisite accuracy. A collimated LED beam can also be utilized.

The entire presetting operation can be automated using the spacing measurement system proposed according to the present invention. This also reliably prevents the specimen and knife from accidentally or undesirably coming into contact, thereby ruling out any damage to the knife and specimen.

### BRIEF DESCRIPTION OF THE DRAWINGS

Further advantages and advantageous embodiments of the invention are the subject matter of the Figures below and their descriptions.

In the individual Figures:

FIG. 1 shows an apparatus according to the existing art for cutting specimens;

FIG. 2 shows an apparatus according to the present invention for cutting specimens, having a light barrier;

FIG. 3 shows an enlarged portion of an apparatus according to the present invention for cutting specimens, having a light barrier.

### DETAILED DESCRIPTION OF THE INVENTION

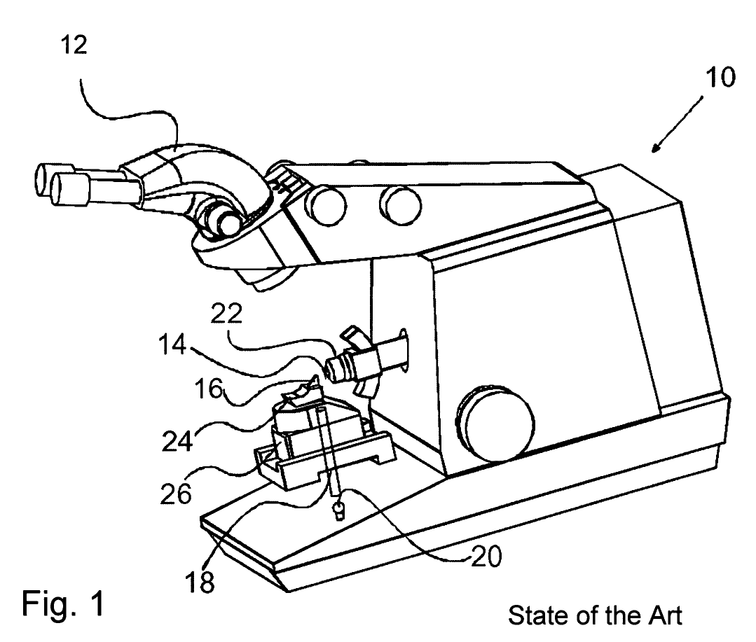

FIG. 1 shows a cutting apparatus 10 with which a specimen 14 is to be cut using a knife 16. Specimen 14 is clamped in a specimen holder 22, while knife 16 is secured in a knife holder 24. For cutting, specimen 14 is guided past knife 16, knife holder 24 being moved by means of carriage 26 on a carriage plane 28. A relative motion is thus generated between knife 16 and specimen 14. Specimen 14 can thereby be preset onto knife 16. In order to minimize stress on specimen 14 and knife 16, the first cuts after the presetting operation should also not be too thick. For many diamond knives, the upper limit of cut thickness can be assumed to be 0.3 μm. This means that before cutting begins, knife 16 must be aligned with specimen 14 to within a few micrometers, and knife 16 and specimen 14 must not touch. This alignment operation is performed under observation through stereomicroscope 12. The spacing between specimen 14 and knife 16 appears in stereomicroscope 12, because of the illumination from below, as a bright light gap. The illumination system is implemented, for example, as a lamp 20 whose light is guided to the desired point using light guide 18.

In an ultramicrotome of this kind it is often impossible, despite lamp 20 and light guide 18 as aids, to estimate exactly the gap between specimen 14 and knife 16 using stereomicroscope 12. Automation of the presetting operation is moreover extremely difficult.

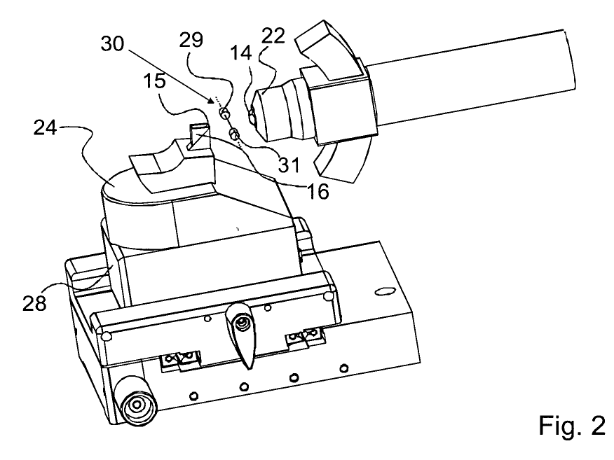

FIG. 2 shows an apparatus according to the present invention for cutting specimens, such as can be implemented e.g. on a microtome or ultramicrotome. With the apparatus according to the present invention the purpose is once again to bring specimen 14 close to knife 16, the spacing between specimen 14 and knife 16 being decreased by a relative motion between specimen 14 and knife 16. Arranged between specimen 14 and knife 16 is a light barrier 30 that comprises a light transmitter 29 and a light receiver 30. Transmitter 29 and receiver 30 are aligned with one another in such a way that the light beam proceeding from transmitter 29 is incident on receiver 30. The light barrier can be mechanically coupled to an external housing (not shown) or to the specimen holder 22, but preferably to knife holder 24 or carriage 28, i.e. mounted thereon. As specimen 14 approaches knife 16, light barrier 30 is penetrated at a defined position. The interruption can be accomplished either by knife 16 or by specimen 14. In the example shown in FIG. 2, the light barrier is mechanically coupled to knife holder 24. A defined, fixed spacing thus exists between light barrier 30 and knife 16, and is not changed even by a translating motion of knife 16. Correspondingly, in the event of a change in the spacing between specimen 14 and knife 16, light barrier 30 is interrupted by specimen 14.

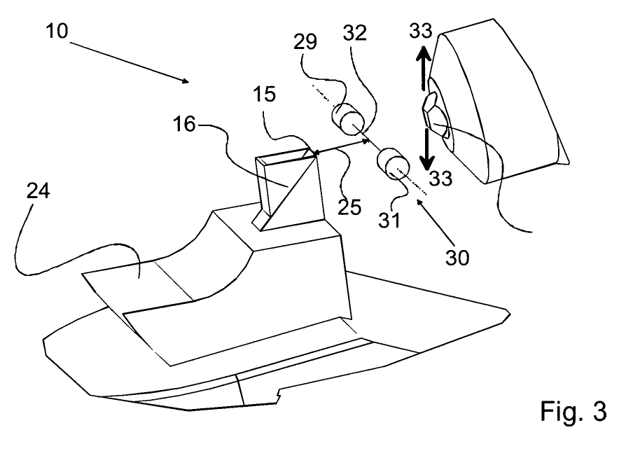

As depicted in FIG. 3 in an enlargement of a portion of apparatus 10 according to the present invention for cutting specimens 14, light barrier 30 is preferably arranged between knife 16 and specimen 14 in such a way that light beam 32 extends parallel to knife edge 15 of knife 16. Based on an accurate knowledge of spacing 25 between knife edge 15 and light beam 32, upon penetration of the light barrier by specimen 14 it is possible to ascertain when specimen 14 is at exactly that spacing 25 from knife edge 15. It is correspondingly important to set spacing 25 as accurately as possible. This can be achieved on the one hand by exact mechanical immobilization of light barrier 30 with respect to knife edge 15. On the other hand, the cross section of the light beam should be kept as small as possible, for which purpose a collimated LED light beam or the light of a laser is a good choice. There are fundamentally no limitations of any kind in terms of the light that is used. The transmitter and receiver must simply be coordinated with one another so that the penetration of light barrier 30 can be detected.

The presetting operation can be automated using the device according to the present invention. For this, firstly knife 16 and specimen 14 are roughly positioned relative to one another; this is preferably done at a spacing of a few millimeters. A motorized cutting motion 33, comprising substantially an up-and-down motion of specimen holder 22, is then activated. At the same time, the spacing between specimen 14 and knife 16 is decreased by way of a feed unit which generates a relative motion between specimen 14 and knife 16. A stepping motor and a spindle, which move knife 16 together with knife holder 24 on a carriage 28 in the direction of specimen 14, can be used, for example, for this purpose. The feed operation remains activated until an interruption of light barrier 30 occurs for the first time.

Accurate detection of the interruption point of light barrier 30 can be further improved by the fact that after light barrier 30 is penetrated for the first time, the feed unit is moved back in the opposite direction in small steps in order to accurately ascertain the interruption point of light barrier 30 once again. The forward or reverse feed speed can also be modified, in particular lowered, for this purpose. After definite detection of the light barrier, a feed action then occurs over the entire spacing 25 minus a few micrometers. This is possible because the exact spacing 25 is known. Once a feed action has occurred over spacing 25 minus a few micrometers, it is possible to switch over automatically to the desired cut thickness and the corresponding feed speed. At the same time, motion 33 of specimen can also be set to the desired cut thickness. After a few cycles without cutting, the first cuts then occur at the desired cut thickness.

Microtomes and ultramicrotomes are usually equipped with an alternating drive system with which the sample is moved slowly at the adjustable cutting speed when within the so-called cutting window, and at a higher return speed when outside the cutting window. The cutting window must usually be adapted to the specimen position and specimen size. A coding device on the alternating drive system permits adjustment of the cutting window.

In a further embodiment of the invention, this cutting window can likewise be set automatically. This is done by arranging light barrier 30 between specimen 14 and knife 16 in such a way that in addition to the detection of spacing 25, it is also possible to detect the position of specimen 14 during its up-and-down motion 33. The interruption of light barrier 30 during up-and-down motion 33 of specimen 14 can be used, by way of the coding device of the alternating drive system, to determine the specimen size and to set the cutting window. In this context, for example, the point in time and duration of the interruption of light barrier 30 by specimen 14 is sensed. Those values can then be conveyed to the coding device of the alternating drive system in order to set the cutting window. The interruption of light barrier 30 can thus be employed to sense the specimen size and position so that a switchover between cutting speed and return speed, and thus the setting of the cutting window, can be accomplished automatically.

What is claimed is:

1. A cutting apparatus for cutting a specimen comprising: a knife, defining a knife edge, a knife holder for clamping the knife, a specimen holder for holding the specimen, a feed device for generating a relative motion between the knife and the specimen, a light barrier being arranged parallel to the knife edge and located between the knife and the specimen, the arrangement of the light barrier is such that the relative motion between the knife and the specimen penetrates the light barrier and thereby ascertains a spacing between the knife and the specimen.

2. The cutting apparatus as defined in claim 1, wherein the light barrier is arranged substantially at the height of the knife blade and at a defined spacing between the knife and the specimen.

3. The cutting apparatus as defined in claim 1, wherein the light barrier is arranged in stationary fashion with respect to the knife or to the specimen.

4. The cutting apparatus as defined in claim 1, wherein the light barrier comprises a transmitter of electromagnetic radiation, in particular a laser or an LED, and a receiver of electromagnetic radiation.

5. The cutting apparatus as defined in claim 1, wherein the transmitter and the receiver are mechanically coupled to the knife holder or to the specimen holder.

6. The cutting apparatus as defined in claim 5, wherein the transmitter and the receiver are mounted in stationary fashion, in particular each in stationary fashion, in a housing wall of the cutting apparatus.

7. The cutting apparatus as defined in claim 1, wherein an alternating drive system for moving the specimen at different speeds is further provided in the cutting apparatus.

8. The cutting apparatus as defined in claim 7, wherein a coding device is provided on the alternating drive system in such a way that an automatic setting of a cutting window can be generated by way of the interruption of the light barrier during an up-and-down motion of the specimen.

9. A microtome or ultramicrotome comprising: a knife, defining a knife edge, a knife holder for clamping the knife, a specimen holder for holding a specimen, a feed device for generating a relative motion between the knife and the specimen, a light barrier being arranged parallel to the knife edge and located between the knife and the specimen, the arrangement of the light barrier is such that the relative motion between the knife and the specimen penetrates the light barrier and thereby ascertains a spacing between the knife and the specimen.

10. A method for bringing a specimen close to a knife of a microtome or ultramicrotome, comprising the steps of:
securing the specimen in a specimen holder and the knife in a knife holder (24);
moving the specimen and the knife toward one another with the aid of a feed device;
providing a light barrier between the knife and the specimen, wherein the light barrier being arranged parallel to a knife edge of the knife;
interrupting the motion of the specimen and the knife toward one another at a defined; and
ascertaining a defined spacing between the knife and the specimen upon the interruption of the light barrier.

11. The method as defined in claim 10, wherein the feed of the feed device is deactivated as a result of detection of the interruption of the light barrier.

12. The method as defined in claim 11, wherein after the interruption of the light barrier, the spacing between the knife and the specimen is decreased by a predetermined amount.

13. The method as defined in claim 12, wherein after the interruption of the light barrier, the feed device is automatically switched over to a feed that corresponds to a predefined cut thickness or speed.

14. The method as defined in claim 12, wherein after the interruption of the light barrier, the feed device is automatically switched over to a feed that corresponds to a predefined cut thickness and speed.

15. The method as defined in claim 13, wherein a cutting window is automatically set using an alternating drive system, an interruption of the light barrier during an up-and-down motion of the specimen being used to code a coding device on the alternating drive system.
